(19) United States
(12) Patent Application Publication
(10) Pub. No.: US 2008/0196592 A1
(43) Pub. Date: Aug. 21, 2008

(54) Fluid Treatment Plant and Use Thereof For Treating a Gas By Adsorption

(76) Inventors: Christian Monereau, Paris (FR); Philippe Merino, Paris (FR)

Correspondence Address: AIR LIQUIDE;Intellectual Property, 2700 POST OAK BOULEVARD, SUITE 1800, HOUSTON, TX, 77056, US

(21) Appl. No.: 11/916,198

(22) PCT Filed: May 18, 2006
(86) PCT No.: PCT/FR06/50453

§ 371 Date: Nov. 30, 2007

(30) Foreign Application Priority Data
Jun. 1, 2005 (FR) 0551463

(51) Int. Cl. B01D 53/02; B01D 39/00

(52) U.S. Cl. 96/112; 55/307; 96/108

(57) ABSTRACT

The invention concerns a plant comprising a portion wherein the fluid path (I/O) is deflected and equipped with a distributor with, in series in the downstream direction (O), a first zone (5) with distribution passages (orifices 6) and a second zone (3), typically a grid or fine-mesh sieve forming diffusion passages, the first passages (6) having a total cross-section not exceeding 20% of the surface of the distributor and the second passages having a total cross-section more than 40% of the surface of the distributor. The invention is applicable to gas treatment by adsorption.

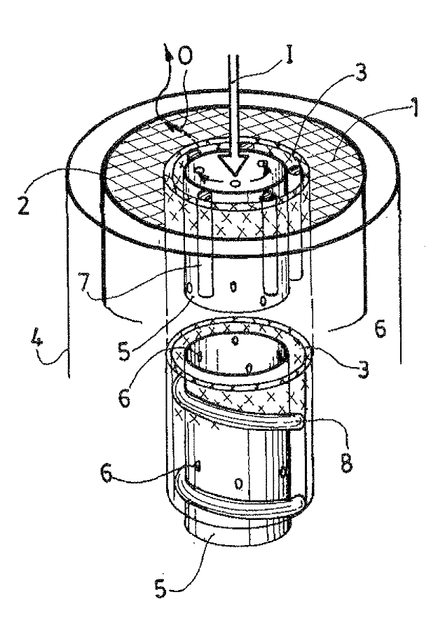

The present invention relates to plants for treating fluids using a particulate material comprising at least one portion in which the fluid path is deflected by at least 45° between a first direction and a second direction, the path modification portion comprises a distributor with, in series in the second direction, a first zone with first distribution passages, and a second zone, spaced from the first zone, with diffusion passages.

It is known that in order to distribute a fluid uniformly across an area permeable to the fluid, a system is used partially forming an obstacle to the free flow of said fluid. The pressure drops thus generated allow a good distribution of the fluid on said area, regardless of the upstream fluid flow conditions. A simple example is that of a perforated tube. To obtain a uniform distribution of the fluid, the pressure drop across the perforations much be equal to several times the kinetic energy of the fluid entering the perforation zone, requiring the creation of numerous microperforations or the use of a porous material, which is prohibitively expensive on the industrial scale and, in combination with a fluid treatment material of the particulate type, for example, an adsorbent, incurs serious risks of clogging.

It is the object of the present invention to propose a fluid treatment plant arrangement with optimized fluid distribution between a first volume in which the fluid flows in a first direction and a second volume in which it flows in another direction, typically perpendicular to the first, with a minimum of dead volume and reducing the risks of clogging, even in the presence of treatment material consisting of fine particles.

For this purpose, according to one feature of the invention, the first passages have a total cross section not exceeding 20%, typically less than 10%, advantageously not exceeding 5%, of the distributor area, and the second passages have a total cross section of more than 40%, typically more than 60%, advantageously more than 70% of the total area of the distributor.

According to particular features of the invention:
the plant comprises only one distributor;
the first zone is formed by a perforated plate;
the second zone is formed by a fine-mesh sieve;
the second zone forms a wall for retaining a particulate material for treating fluids.

In the context of the present invention, distributor area means the developed surface area of the simple geometric body (cylinder, cone, plane) representing as closely as possible the distribution interface between the upstream and downstream sides of the distributor.

The present invention also relates to the use of such an plant for treating a gas by separation by pressure and/or temperature swing adsorption, particularly for producing a gas from a gas mixture containing said gas.

Other features and advantages of the invention will appear from the following description of an embodiment provided for illustration, in conjunction with the drawing appended hereto in which:
the single FIGURE schematically shows a perspective and fictive view of two embodiments of an plant according to the invention.

The single FIGURE schematically shows a portion of a fluid treatment plant operating by the passage of said fluid radially across an annular volume 1 comprising at least one adsorbent particulate material contained between two concentric perforated walls 2 and 3, the whole being placed in a peripheral shell that is also concentric 4.

According to one aspect of the invention, the portion of distributor between the incoming fluid stream I, typically coaxial with the walls 1, 2, and 3, and sending said fluid radially, in the direction O, through the adsorbent volume 1, comprises a central tube 5 provided with perforations 6 and kept apart from the inner grid 3 by longitudinal spacers 7 (top of the figure) or helical spacers 8 (bottom of the figure), for example by mixing on the outer wall of the tube 5.

According to one feature of the invention, the perforations 6 of the tube 5 are dimensioned to form distribution passages, that is with a reduced flow section compared to the wall area of the tube 5 and causing a high pressure drop, while the passages of the grid 3 are dimensioned to form diffusion passages, that is offering a high flow section compared to the developed surface area of the tube/grid interface and accordingly causing a very low pressure drop. More specifically, the orifices 6 are calibrated orifices in the form of medium-sized holes or slits, uniformly distributed in a small number on the surface of the tube 5, whereas the grid 3, made with a fine mesh, from metal or fabric, offers a high flow section with numerous passages distributed over the whole area of the grid.

According to one feature of the invention, the ratios of the flow areas between the second passages and the first passages are higher than 2, typically, higher than 5, advantageously higher than 10. More specifically, the first passages or orifices 6 have a total cross section not exceeding 20%, typically not exceeding 5%, of the wall area of the tube 5, while the passages of the grid 3 represent a flow section of more than 40%, typically more than 60%, advantageously more than 80%, of the area of the grid.

It may be understood that in the application with fluid treatment by passage through at least one particulate material contained between the grids 2 and 3, the high flow area offered by the grid 3 makes the latter relatively immune to the risks of clogging by the particles of adsorbent material 1.

The present invention has a preferential application in the treatment of gases by pressure or temperature swing adsorption in adsorbers with radial gas flow in at least one adsorbent mass comprising at least one component capable of adsorbing one of the constituents of the gas mixture, typically a zeolite, a carbon sieve, a silica or alumina gel, for the production of gas or the purification of gas mixtures before subsequent treatment.

Although the invention has been described in relation to particular embodiments, it is not limited thereby but is susceptible to modifications and alternatives that will appear to a person skilled in the art within the scope of the claims below.

1-9. (canceled)

10. A plant for treating fluids using a particulate material, comprising at least one portion in which the fluid path is deflected by at least 45° between a first direction and a second direction, said portion comprising a distributor comprising, in series in the second direction, a first zone with first distribution passages and a second zone, spaced from the first zone, with diffusion passages, wherein the first passages have a total cross section not exceeding 20% of the distributor area, and the second passages have a total cross section of more than 40% of the distributor area.

11. The plant of claim 10, wherein the first passages have a total cross section not exceeding 5% of the distributor area.

12. The plant of claim 10, wherein the second passages have a total cross section of more than 70% of the distributor area.

13. The plant of claim 10, wherein the first zone is formed by a perforated plate.

14. The plant of claim 10, wherein the second zone is formed by a fine-mesh sieve.

15. The plant of claim 13, wherein it comprises spacer elements between the plate and the sieve.

16. The plant of claim 10, wherein the second zone forms a wall for retaining a particulate material for treating fluids.

17. The plant of claim 10, comprising only one distributor.

18. The use of the plant of claim 10, for treating a gas by pressure or temperature swing adsorption.
